(19) United States
(12) Patent Application Publication
(10) Pub. No.: US 2012/0041944 A1
(43) Pub. Date: Feb. 16, 2012

(54) METHOD FOR AUTOMATIC CHARACTERIZATION OF TELEPHONY USERS TROUGH LABELS

(75) Inventors: Enrique Frías MARTINEZ, (US); Manuel Cebrián Ramos, (US); Juan Moises Pascual Leo, (US)

(73) Assignee: TELEFONICA, S.A.

(21) Appl. No.: 12/857,224

(22) Filed: Aug. 16, 2010

(51) Int. Cl. G06F 17/30

(52) U.S. Cl. 707/722; 707/E17.009; 707/E17.014

(57) ABSTRACT

The invention consists of a method for automatic characterization of telephony users through labels, that comprises the steps of, for a particular user, collecting the origin and destination communication identifiers corresponding to the user, searching for the service providers in a data base in a yellow pages-like service, querying a search engine for the service provider and extracting the labels that correspond to the service provider comparing the labels to elaborate a list of the most used and linking the user to the list.

### FIELD OF THE INVENTION

The present invention deals with the automatic building of meta-information, and its matching with the communication patterns of a telephony user, in order to know what type of services are being requested by different users.

### STATE OF THE ART

Communication companies collect end user's communication activity information, mainly for charging and billing purposes. This information represents a quantitative analysis of the communication pattern of a user. In the case of phone companies, call detail records (CDRs), allow to collect how many times a certain user interacts with a certain number by means of a range of telephony services like outgoing or incoming calls, SMS, MMS, etc.

Existing technology allows inferring many interesting behavioural aspects of every user scrutinized, by analyzing communication activity information (like CDR). However the semantic of the analysis is limited to the meaning of the identifiers used in the communication. This is, in the case of telephony, CDR contains phone numbers, which at most, can be matched with real persons owning a subscription, but in some cases those phone numbers belong to services from which much more interesting information could be extracted. That information is normally placed in a different communication plane that the one used to establish the communications represented in the CDR. The plane where additional information can be extracted using a phone number as a key is normally is the Internet (YellowPages-like services, Search engines, web pages, etc). Therefore, it is interesting to combine the information from the communication activity of users, with the information that can be extracted or inferred from the Internet.

The user labelling of any information source in the Internet is one of the most important features of the WEB 2.0[1]. Some typical examples of these environments are Flickr, where user labels their photographs, or delicious, where the user tags the different information sources of the Internet. Implicitly, these users, through their information tagging, are showing their interests for this information. This idea has been utilized to generate user models which capture their interest utilizing this explicit tagging which has been realized in the Internet.

User generated tags, or manual tagging of information, is considered a useful technique, though its applicability depends on factors like: end users criteria to suggest meaningful labels, uniformity of aforementioned criteria among the end users, and the manual effort required to produce significant amounts of tags. All in all, the adoption of automated techniques to label certain information sources could significantly avoid these drawbacks.

Summarizing, the information that can be found by analyzing Internet content related to services and companies is very rich and sparse, making it very much interesting and difficult to include as part of the behavioural analysis of the communication patterns between users and services/companies.

The main drawback of the existing user's characterization technology based on labels or tags information from services is that it is based in the explicit tagging made by the users over the information that is interesting for them. The modelling of users' interests (Internet in this case) from some information introduced by them in an explicit way, has some different problems, overall: (1) users couldn't know how to describe with enough detail the information which they are labelling, (2) they can make labelling too generics and/or repetitive which don't add relevant information and (3) the generation of models that capture the users interests depend completely of users collaboration with Internet tagging systems.

The detailed literature about patents is focused in this problem: US 2008/004301 A1 “System and Method for Inferring Users Interests Based on Analysis of User-Generated Metadata” from Yahoo! Inc., utilizes the information introduced by users in the Internet in order to generate interests models. It solves a technical problem, nevertheless the limitations are those described before. Some patents describe user information tagging with reference to cellular phones: US 2005/0208954 A1 “User-Tagging of Cellular Telephone Locations” from Microsoft Corporation, discloses a system in which the user enters manually into his mobile phone some labels about his position employing a GPS system to assign labels to a physical (geographical) position. One more time the principal drawback of this solution is that the labelling is made by users in an explicit way, with the limitations that this implies. Furthermore, this method is not catered in generating users' models but models of users' environments employing labels.

Generally, the principal limitation of these methods is the limited trustiness of obtained labels taking into account that they are obtained from the information explicitly written by the user.

Indeed, the created models till now depend deeply on the implication of users in the labelling of information, characteristic which always limits the applicability of the model to those users which have an active presence in the Internet labelling forums.

### DESCRIPTION OF THE INVENTION

This invention is focused on: (1) the modeling of users interests and (2) the automatic generation of labels that describes the services utilized by the user. It is proposed, therefore, to combine both sources of information obtained by automatic means, to provide a better understanding on how users interact with services, through the analysis of their communication patterns. This object is achieved by the features of claim 1. Advantageous embodiments are defined in the dependent claims.

Thanks to the method of the invention it is possible to automatically generate labeling meta-information associated with every communication end-point identifier, identified through the process of collecting communication activity from users.

### BRIEF DESCRIPTION OF THE DRAWINGS

To complete the description and in order to provide for a better understanding of the invention, a set of drawings is provided. Said drawings form an integral part of the description and illustrate a preferred embodiment of the invention, which should not be interpreted as restricting the scope of the invention, but just as an example of how the invention can be embodied. The drawings comprise the following figures:

FIG. 1: depicts the overall process proposed along by this invention.

FIG. 2: the structure of the service characterization database

FIG. 3: shows the method used to generate user models that capture users' behavior from their communication activities

FIG. 4: shows the structure of the user model obtained.

### DESCRIPTION OF A PREFERRED EMBODIMENT OF THE INVENTION

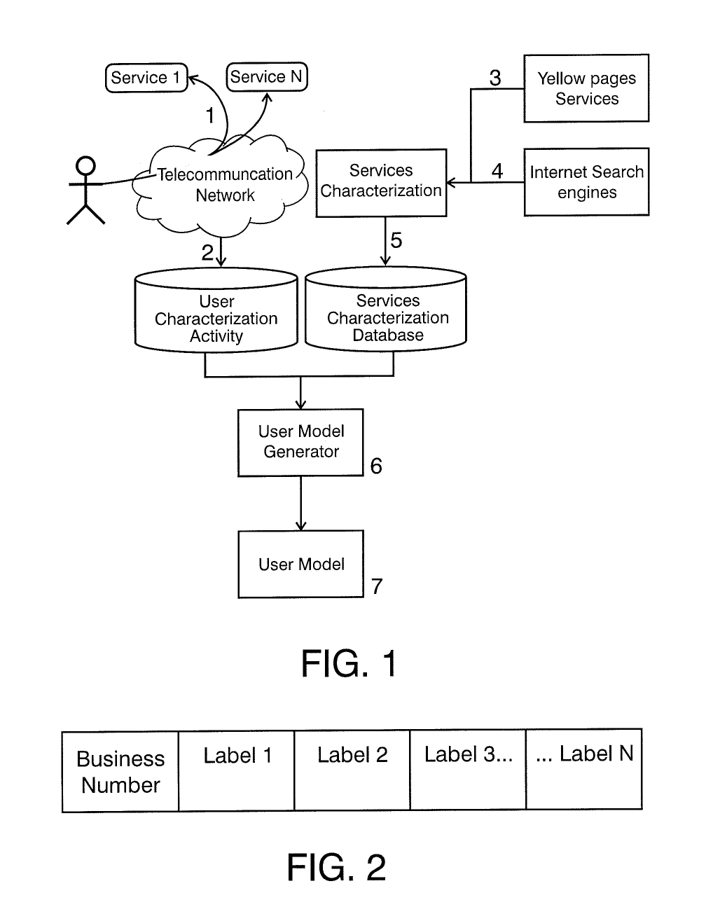

By automating this process, a richer behavioral analysis can be conducted, as follows:
a. The service or access provider, for every user, collects communication activity. This information contains origin and destination communication identifiers, including other information like duration, type of communication, etc. The identifiers are telephone numbers that uniquely identify a user or a group of users. This type of information will be defined as activity database (steps 1 and 2 in FIG. 1). The information is then stored.
b. Yellow pages-like services contain comprehensive lists of companies providing services. This information comprehends company's name, description, categorization of the service being provided, some description, and the ways that this company services can be reached (phone number, Skype identifiers, SMS, e-mail, etc) (step 3 in FIG. 1).
c. Internet search engines contain detailed descriptions about most of the companies being enumerated in yellow pages services. By querying any of the most popular search engines, additional information about a certain company name, can be easily obtained. Simple frequency analysis of the most relevant words present in the description of a company (obtained through Internet search engines), combined with the categorization information of the yellow pages directory, produces a list of meaningful words that will be used as labels, associated to every company (step 4 in FIG. 1).
d. The combination of these labels, with the most relevant information obtained in step b is used to produce a services characterization database. (step 5 in FIG. 1).
e. Finally, by matching communication identifiers from the activity database stored in step a., with the communication identifiers present in the services characterization database, it is possible to link user's communication patterns with labels belonging to specific services and companies, and communication activity behavior, in an automatic way.

The modeling of user interests is made through the characterization of the user's behavior in the network from which the communication activity information has been extracted. Basic telecommunication services usage data collected in the network also allow the extraction of endpoint identifiers (phone numbers, etc.) representing the communication habits of each user. Those habits can be further classified in order to separate common communication peers (family, workmates, buddies, etc.) from those representing services (restaurants, hotels, etc.) each user interacts with.

Therefore, this first step constitutes the building of the information model that supports each user's communication activity pattern when interacting with communication endpoints, categorized (with high probability) as ‘services’. This model will be called “activity database”. The second step of the invention comprises the automatic generation of the labels that better describe services found on Internet search engines and yellow-pages-like services. This stage of the method being described can be fed with the communication identifiers found in the first step (in order to link labels to those identifiers), or, on the contrary, run without input information in order to build a comprehensive list of services identifiers, and their corresponding labels.

The automatic generation of labels describing the services that users are communicating with is made by combining the information contained in yellow pages-like services (linking company/services names and descriptions with their contact information numbers and identifiers like e-mail, Skype, etc) with the information obtained from the Internet by querying a search engine with the names of those companies/services. This is, by analyzing the communication activity of a user, the proposed method is able to characterize the patterns followed to interact with certain communication end-points (represented by phone numbers, emails, etc).

The implicit generations of the labels that characterize a communication identifier (e.g.: a phone number) increase the trustiness and predictability of the characterization models, in relation to its explicit generation. This invention suggests to include a measure that weights the relevance of each of the labels, avoiding the subjective perception of the user generated tags.

The information obtained from Internet search engines is processed using an algorithm. This technique consists on representing the content of a text through the assignation of a counter to each of the text's words. Once all the text has been processed, the algorithm representation sorts the words in appearance order. This technique typically employs an initial filtering phase where not relevant words (articles, possessives . . . ) and the punctuation symbols are eliminated. And at the end of this processing, only most important words are revealed, and used to describe the companies/services that users are communicating with.

The list of words extracted using the algorithm represents the labels set used to describe the services. And this set is linked to the communication identifiers used by the companies/services considered in the second step of the invention. This combination is the services characterization database.

The following sequence of steps describe the technical process suggested by this invention to match those labels which better describe a certain communication identifier, representing a service or company providing services, with the communication activity from a certain user:
1. Communication activity from a user is grouped in an empty model where the different communication end-point identifiers are listed.
2. For each user communication is checked whether the destination number belongs to the characterization services database. If the destination number is included in the database, labels are created to characterize the service.
3. For each label, two possibilities are available: if the label is new for the user, it is included and a meter is initialized, or, if the label is already included in user model, the value in the meter is modified in an accordingly way.

This meter can be generated in different ways depending on the models needs. Two examples of that would be: (1) an incremental counter, which would be initialized in one, as if the label is appearing for the first time in the model and then would be increased by one for each appearance (a straight line graph with slope 1); and (2) an incremental or sigmoid curve whose value is 0 (zero) between [0.1) a sinusoid between [1.20) and a value of 1 from 20. In this case the axis X represents the number of times that the label has been generated and the axis Y represents the importance of that label. I.e., when a label appears for the first time its value is 0 (zero), from there it takes values between 0 (zero) and 1 along the sinusoid until it appears at least 20 times and then the value of the counter is 1. FIG. 2 presents a schema of the steps followed to generate the models considering the method for generating a counter given as first example.

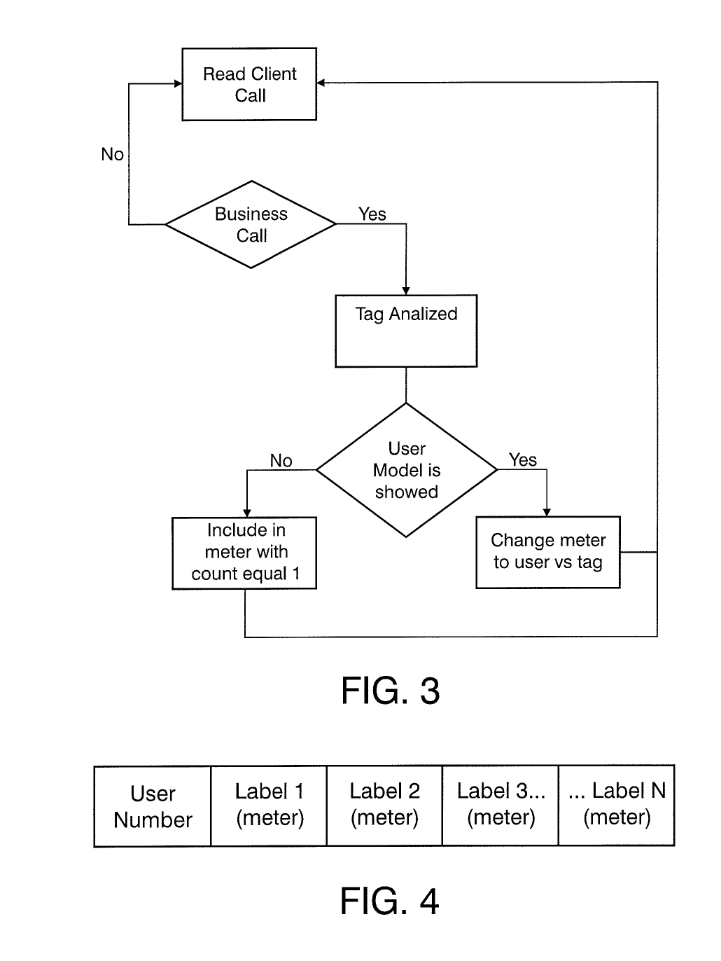

As a result, for each user is obtained a set of labels, each with a counter that indicates the importance of this identifier. In FIG. 3 the structure of user models obtained is presented. The number of labels is not necessarily equal among users and depends on the number of communication that the user has made to companies and services listed in the guide.

This invention allows matching communication identifiers that likely represent user's interaction with services or companies, producing a richer representation of user interaction and communication patterns.

By linking the information obtained from the automatic generation of the aforementioned labels, with the users originating (or receiving) the communication activity, this invention builds a model comprised of the association of both. This model describes, through automatically generated labels, what type of services a user interacts with.

Both, users' communication activity and characterization service database can be labeled like described in FIG. 1. Examples of that may contain the service description database for each company with distinct characterization.

In this text, the term “comprises” and its derivations (such as “comprising”, etc.) should not be understood in an excluding sense, that is, these terms should not be interpreted as excluding the possibility that what is described and defined may include further elements, steps, etc.

1. Method for automatic characterization of telephony users through labels, that comprises the following steps:
a. for a particular user, collecting the origin and destination communication identifiers corresponding to the user and contacted service providers
b. searching for the service providers in a data base in a yellow pages-like service
c. querying a search engine for the service provider and extracting the labels that correspond to the service provider
d. combining the labels extracted in c. with the data in b. to elaborate a list of labels and corresponding service providers
e. linking the identifiers collected in to the list in d. and thus automatically match the user with the labels.

2. A method as in claim 1 wherein in step a also the duration and type of communication is collected.

3. A method as in claim 1 where the information collected in a stored in an activity database.

4. A method as in claim 1 where the information collected in b and c is stored in a service characterization database.

5. A method as in claim 1 wherein if the label is new for the user, a meter is initialized, or, if the label is already included in user model, the value in the meter is modified accordingly.
